(19) United States
(12) Patent Application Publication
(10) Pub. No.: US 2006/0095270 A1
(43) Pub. Date: May 4, 2006

(54) Brand/generic classification system

(76) Inventor: Joseph Somerville, Gilbertsville, PA (US)

Correspondence Address: BAKER & BOTTS, 30 ROCKEFELLER PLAZA, NEW YORK, NY, 10112, US

(21) Appl. No.: 10/517,855

(22) PCT Filed: Jun. 13, 2003
(86) PCT No.: PCT/US03/18795

§ 371 Date: Sep. 21, 2005

Related U.S. Application Data
(60) Provisional application No. 60/390,559, filed on Jun. 21, 2002.
(60) Provisional application No. 60/396,284, filed on Jul. 3, 2002.

(51) Int. Cl. G06Q 99/00

(52) U.S. Cl. 705/1

(57) ABSTRACT

A method and system for categorizing a medical or a pharmaceutical product. The method includes determining an originator indicator for the product (220), determining a-patent status (240), determining a tradename indicator for the product (250), and categorizing the product (260) as a branded product or a generic product, using the determined originator indicator, patent status indicator, source indicator, and tradename indicator.

### CROSS-REFERENCE TO RELATED APPLICATIONS

This application claims priority to U.S. provisional application 60/390,559 filed on Jun. 21, 2002, entitled “Brand/Generic Classification System,” and U.S. provisional application 60/396,284 filed on Jul. 3, 2002, entitled “Brand/Generic Classification System,” both of which are hereby incorporated by reference.

### BACKGROUND OF THE INVENTION

The present invention relates to techniques for implementing market research on medical and pharmaceutical products, and more specifically, to techniques which categorize such products as being a “brand” name product or a generic product.

Medical and pharmaceutical products are often sold in both a branded and generic form. For example, the common drug aspirin is sold both under various household brand names including Anacin®D, Bayer®, and Excedrin®, as well as generically by numerous manufacturers. Further, some generically supplied products, known as “branded generics,” are sold as a generic product under a store or other brand name, e.g., CVS® aspirin. It is often crucial for market researchers to be able to categorize medical and pharmaceutical products as belonging to one of these categories, and to group all members of such categories together.

At present, there exists no uniform technique for creating a report which breaks pharmaceutical or other medical products into brand, generic or branded generic categories. Thus, intricate workarounds and unique market definitions have been required in order to implement the grouping of branded and generic products. In order to combine various generic products having the same name into one group, one would need to manually group such products and then redefine the newly formed group. This is a tedious and time consuming process.

Accordingly, there exists a need in the field of medical and pharmaceutical product research for a standardized technique to categorize medical and pharmaceutical products as Branded, Generic or Branded Generic, without simply resorting to pricing information which can corrupt results depending on market factors.

### SUMMARY OF THE INVENTION

An objective of the present invention is to provide a standardized technique to categorize medical and pharmaceutical products as Brands, Generics or Branded Generics.

A further objective of the present invention is to provide a technique that enables a common, standardized language and definition for categorizing medical and pharmaceutical products, while providing the opportunity for customization and redefinition where a customer feels it is appropriate.

In order to meet these objectives and others that will become apparent with reference to the disclosure herein, techniques for determining whether a medical or pharmaceutical product is branded, generic, or a branded generic are provided. In one embodiment of the invention, a method is provided which includes the steps of (i) determining whether or not the product was the first introduction of a new chemical entity, (ii) determining whether the product has an associated patent, (iii) determining whether the product is available from a single-source, multiple sources, or from co-licensed sources, (iv) determining whether the product is marketed or sold under a trade name or a chemical name, and (v) utilizing the information determined in steps (i)-(iv) to categorize the product as a branded, generic, or a branded generic product. Preferably, when determining whether or not the product was the first introduction of a new chemical entity, an Origin indicator classifies the product as an originator, non-originator, or other. Preferably, when determining whether the product has an associated patent, a Patent Status indicator classifies the product as on-patent, off-patent, or other. Preferably, when determining whether the product is available from a single-source, multiple sources, or from co-licensed sources, a Source indicator classifies the product as single source, multiple source, co-licensed, and other. Preferably, when determining whether the product is marketed or sold under a trade name or a chemical name, a Tradename indicator classifies the product as tradename, non-tradename, and other.

The accompanying drawings, which are incorporated and constitute part of this disclosure, illustrate a preferred embodiment of the invention and serve to explain the principles of the invention.

### BRIEF DESCRIPTION OF THE DRAWINGS

FIG. 1 is a functional diagram of a system in accordance with a preferred embodiment of the present invention; and

FIG. 2 is a flow diagram illustrating the basic steps implemented in the system of FIG. 1.

Throughout the figures, the same reference numerals and characters, unless otherwise stated, are used to denote like features, elements, components or portions of the illustrated embodiments.

### DESCRIPTION OF PREFERRED EMBODIMENTS

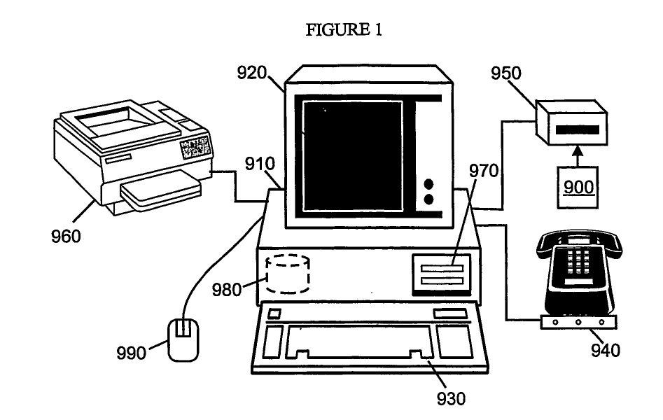

Referring to FIG. 1, one preferred arrangement of the present invention requires the execution of several logical steps, each of which are discussed below. All steps may be performed either manually or on a system including a computer executing standard off the shelf statistical software. It should be noted that the following description is by way of example and not by limitation, with certain embodiments being described in order to best explain the principles of the present invention.

The computer system of FIG. 1 includes a processing section 910, a display 920, a keyboard 930, and a communications peripheral device 940 such as a modem. The system typically includes a digital pointer 990 such as a “mouse”, and can also include other input devices such as a card reader 950 for reading an account card 900. In addition, the system can include a printer 960. The computer system typically includes a hard disk drive 980 and one or more additional disk drives 970 which can read and write to computer readable media such as magnetic media (e.g., diskettes or removable hard disks), or optical media (e.g., CD-ROMS or DVDs). The disk drives 970 and 980 are used for storing data and application software.

In order to better characterize the “brand-ness” or “generic-ness” of a product, the present invention provides a systematic approach with four criteria to determine the product's status. Categorizing a pharmaceutical or medical product herein refers to determining whether or not the product is branded, generic, or otherwise. The four criteria to determine the product's status preferably take the form of Originator, Patent Status, Source, and Tradename indicators. The purpose of using the four indicators is to refine description around brand and generic so as to better reflect today's market environment, which may reflect the categories of “Brand,” “Co-Licensed/Co-Marketed,” “Generic,” “Trademark Branded Generic,” and “Novel Delivery System.”

Products are thus characterized at two levels. At the primary level, the product is characterized as either branded, branded generic, or generic. At the secondary level, the product is further characterized based on combinations of Originator, Patent Status, and Source, and Tradename indicators, which are referred to as “OPST”. The primary level characterization is determined based on an analysis of the secondary characterizations, as will be described below.

The four indicators preferably used to determine whether a product is branded or generic will now be described. First, the Originator indicator categorizes products based on whether or not the chemical or molecule in that product was the first introduction or not. In a preferred embodiment, the Originator indicator classifies a product in one of six categories, originator, non-originator, non-applicable over the counter (“OTC”), other non-applicable, unknown, or other. In this preferred embodiment, when determining the Originator value for a product that has both Prescription and OTC form/strengths or packs, the Originator indicator is determined by the prescription form/strength or pack. Generally, the Originator indicator will either be a originator or non-originator, and not OTC, in such cases.

A product manufactured by the originator of a molecule, containing that molecule, will be assigned the Originator value of “originator”. A manufacturer is designated as the originator of the molecule if the manufacturer holds the original patent to the molecule. A product will also be assigned an originator designation when a manufacturer has co-launched the original molecule under a joint-licensing agreement.

Regarding combination drugs, it is possible that such drugs may be assigned an originator designation several times. Since the originator designation is based on the individual molecule originator, it is immaterial if the manufacturer was the first to put the molecule in a combination product. If a product has more than one ingredient (molecule) and the manufacturer of that product was the originator of any of the molecules, the originator designation should be applicable. A combination product may receive an originator designation several times if the originator of each molecule manufactures a combination product. This applies regardless of which company was the first company to put the combination product together. If the originator of the molecule sells the patent to another manufacturer, the originator on the product retains the originator designation, even though the manufacturer of the new product did not originate the molecule. For a joint-licensing agreement, both products will receive the originator designation. This occurs when the product is still on patent.

A product is designated as “non-originator” if the molecule is off-patent and is a generic of the originator molecule. This rule applies to branded generics. Any product containing a molecule or a combination of molecules that were originated by another manufacturer is generally a non-originator. Generic products produced by a manufacturer who is a subsidiary of the Brand/Originator manufacturer are designated as non-originator. Likewise, any product that comes onto the market specifically designated as a “generic” product, and if the molecule is from the originator manufacturer but from a specific separate generic division, and is listed as a separate product and under the separate manufacturer, receives a non-originator designation. Finally, a product is designated as non-originator if the manufacturer is not the originator of its associated molecules, even if it is the first to market with a unique molecule combination.

A product is designated as “OTC” when it is available over the counter. It is possible for packages within the same product to have different indicators. For example, one strength of a product might require a prescription, while other strengths of the same product may be available over the counter. A similar situation can occur with generic products with the same name which are available both over the counter and by prescription. Some of the like-named products may represent over the counter strengths while others may represent prescription strengths. Thus, the same product name would be reported under multiple Brand/Generic designations. The OTC designation is generally applied to products that are not prescription and have not switched from prescription to OTC status.

Preferably, a product is designated as “non-applicable other” if it is considered a non-product. This group contains general discussion and institutional products. Likewise, a product may be designated as “unknown” if it cannot be determined. Finally, a product is designated as “other” if it cannot be placed in the other categories. The OTC, non-applicable other, unknown and other categories may be aggregated into a single group.

The second indicator, for Patent Status, categorizes drugs based upon the patent protection status of their molecule. Such protection status may be determined based upon general patent knowledge, or alternatively, upon in-depth patent research. In a preferred embodiment, the Patent Status indicator may take the values of on-patent, off-patent, OTC and other.

A product is designated as being “on patent” if the chemical equivalent of the product is available from only one manufacturer. Historically, some products will show that if product is only available from a single source, it was determined as on patent, even though all patents associated with the product may have expired and the product is very old.

A product that is more than 20 years old is designated as being off-patent (included are patented line extensions of a product) since most product patents do not last more than 20 years. Off-patent is also applied if the chemical equivalent of the product is available from more than one manufacturer. OTC products and products that do not fit in the other categories (“other”) may be aggregated.

The third indicator, for Source, is based on product availability from a manufacturer or manufacturers where the product must be chemically equivalent. In a preferred embodiment, the Source indicator may take the values of single source, multiple source, co-licensed, OTC, and other.

A product is designated as “single source” if that product (rather than the chemical) is only available from one manufacturer. Products marketed as a separate trademarked product, and which is available in unique form/strengths, are designated as single source. However, if there is a unique form/strength that is not a separately marketed product, but it is just one of the many form/strengths of a multi-source product that happens to be unique, then the whole product (and all of its form/strengths) will take its source code from the product, not the exception which is the unique form/strength.

An example is the product Dexedrine. Dexedrine is available in multiple forms, of which the Spansule form is unique. As such, Dexedrine is designated as single source, although various products are available for the associated molecule (Dextroamphetamine). Dexedrine Spansule is not a unique product; it is one of the forms associated with the product Dexedrine. When approval is confirmed for other Dextroamphetamine's in Spansule form, Dexedrine's source designation will change to multi-source.

A product is designated as “multi-source” if the chemical equivalent, as well as the combination, of the product is available from more than one manufacturer. Likewise, a product is designated as multi-source for manufacturer-not-stated and private-label products. A product is considered multi-source if several products having the same product name only differ by different form/strengths. Some manufacturers such as Baxter or Abbott manufacture hospital forms or strengths of other manufacturer's products (i.e., Hospital re-packaging) and their associated products are coded as multi-source.

A product is designated as “co-license” when two companies have an agreement to develop or manufacture or market their version of the same drug, under separate tradenames. In some instances, co-license arrangements can include drugs with the same tradename. Co-license should not include co-promotion agreements. As with other indicators, OTC products and products that do not fit in the other categories (“other”) may be aggregated.

The fourth indictor, Tradename, categorizes drugs based on the name by which they are marketed. Products marketed and sold by the chemical name are considered non-tradename; all others are considered tradename. In a preferred embodiment, the Tradename indicator may take the values of tradename, non-tradename, OTC, and Other.

A product is designated as “tradename” when a tradename, commercial or non-chemical name is used by one manufacturer to identify their product. It is usually not the chemical name. A product is designated as “non-tradename” when a generic or chemical name used for a product. Also, the chemical name could have been a tradename at one time. As with other indicators, OTC products and products that do not fit in the other categories (“other”) may be aggregated.

Once the Originator, Patent Status, Source, and Tradename indicators have been determined, the product may be primarily categorized as either branded, branded generic, or generic. In a preferred embodiment, a product is designated as a Branded product based on the Originator, Patent Status, Source, and Tradename indicators as shown in Table I.

TABLE I

| | Secondary Level | | | |
|---|---|---|---|---|
| Primary | | Patent | | |
| Level | Originator | Status | Source | Tradename |
| Brand | Originator | On-patent | Single-source | Tradename |
| | Originator | On-patent | Multi-source | Tradename |
| | Originator | On-patent | Co-Licensed | Tradename |
| | Originator | On-patent | Single-source | Non-Tradename |
| | Originator | On-patent | Multi-source | Non-Tradename |
| | Originator | On-patent | Co-Licensed | Non-Tradename |
| | Originator | Off-patent | Single-source | Tradename |
| | Originator | Off-patent | Multi-source | Tradename |
| | Originator | Off-patent | Co-Licensed | Tradename |
| | Originator | Off-patent | Single-source | Non-Tradename |
| | Originator | Off-patent | Multi-source | Non-Tradename |
| | Originator | Off-patent | Co-Licensed | Non-Tradename |
| | Non-Originator | On-patent | Single-source | Tradename |
| | Non-Originator | On-patent | Multi-source | Tradename |
| | Non-Originator | On-patent | Co-Licensed | Tradename |
| | Non-Originator | On-patent | Single-source | Non-Tradename |
| | Non-Originator | On-patent | Multi-source | Non-Tradename |
| | Non-Originator | On-patent | Co-Licensed | Non-Tradename |

As shown in Table I, a Brand (or Branded) product is generally first time chemical entity marketed as part of created product, or a product is marketed under its distinctive tradename. However, a Brand product can be a product that was never launched with a tradename, as a chemical name could have been a tradename at one time. It should also be noted that no product garners the “Brand” designation simply because of a subsidiary association with the product's originator. Further, a Brand product may exist where a current product manufacturer purchased the product from its originator, and the Brand product had a tradename.

When a Brand product is repackaged, then that repackaged product is a Brand. One caveat is that Brand names used for more than one product can occur, and should be treated accordingly. Finally, an exception may occur where a product is purchased from an originator and resold; the product purchased from an originator is considered Branded, while other products are considered Generic.

In a preferred embodiment, a product is designated as a Branded Generic product based on the Originator, Patent Status, Source, and Tradename indicators shown in Table IL Branded Generic products are forms of off-patent products or a molecule copy with a tradename of off-patent products. Products that fall into this category are typically unique combination of molecules and/or offer unique delivery systems.

TABLE II

| | Secondary Level | | | |
|---|---|---|---|---|
| Primary | | Patent | | |
| Level | Originator | Status | Source | Tradename |
| Branded | Non-Originator | Off-patent | Single-source | Tradename |
| Generic | Non-Originator | Off-patent | Multi-source | Tradename |
| | Non-Originator | Off-patent | Co-Licensed | Tradename |
| | Non-Originator | Off-patent | Single-source | Non-Tradename |
| | Non-Originator | Off-patent | Co-Licensed | Non-Tradename |

As shown in Table II, a Branded Generic product is generally a product that was previously marketed under a Brand name and is currently marketed in another way (via unique packaging), and is produced by a manufacturer other than the Originator. An exception may occur where there is a possible switch from Branded Generic to Brand.

In a preferred embodiment, a product is designated as a Generic product based on the Originator, Patent Status, Source, and Tradename indicators shown in Table III. When a brand name drug's patent expires, other pharmaceutical companies can produce the same active chemical compound and sell the drug under its generic name. Generally, they are available from multiple sources, no longer under patent protection, usually equivalent to an existing brand name medication, and marketed under their chemical name.

TABLE III

| | Secondary Level | | | |
|---|---|---|---|---|
| Primary | | Patent | | |
| Level | Originator | Status | Source | Tradename |
| Generic | Non-Originator | Off-patent | Multi-source | Non-Tradename |

Numerous manufacturers may produce a Generic product. Any manufacturer can produce a Generic product, even the originator or subsidiary of the Branded originator manufacturer. As shown in Table IV, products produced by a subsidiary of the Branded originator manufacturer are designated as a Generic product, e.g., if they are not part of the Brand line and are marketed under the chemical name.

TABLE IV

| | Secondary Level | | | |
|---|---|---|---|---|
| Primary | | Patent | | |
| Level | Originator | Status | Source | Tradename |
| Brand | Originator | Off-patent | Multi-source | Tradename |
| Generic | Non-Originator | Off-patent | Multi-source | Non-Tradename |

Finally, a product may be designated as falling into the Other-Brand/Generic category. As shown in Table V, such a category could include information that does not fall into an existing category, any product that has a value of “other” for any or all of the four OPST indicators, or for the purpose of developing new categories.

TABLE V

| | Secondary Level | | | |
|---|---|---|---|---|
| Primary Level | Originator | Patent Status | Source | Tradename |
| Other- | Other | Other | Other | Other |
| Brand/Generic | Other | Any Value | Any Value | Any Value |
| | Any Value | Other | Any Value | Any Value |
| | Any Value | Any Value | Other | Any Value |
| | Any Value | Any Value | Any Value | Other |

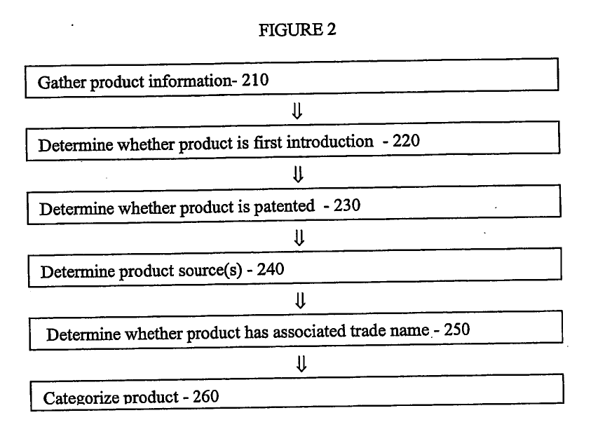

Referring next to FIG. 2, the logical steps implemented in the preferred methodology for determining whether a medical or pharmaceutical product is branded, generic, or a branded generic will be described with reference to the flow diagram 200. In step 210, basic information concerning the product is gathered. In step 220, a determination is made as to whether the product was the first introduction of a new chemical entity. In step 230, a determination is made as to whether the product has an associated patent. Next, in step 240, the product availability is determined, and in step 250, a determination as to whether the product is marketed or sold under a trade name or a chemical name. Finally, in step 260, the information determined in steps 220-250 is used to categorize the product as a branded, generic, or a branded generic product.

It will be appreciated by those skilled in the art that the method of FIG. 2 can be implemented on various standard computer platforms operating under the control of suitable software, such as on the platform of FIG. 1. In some cases, dedicated computer hardware, such as a peripheral card in a conventional personal computer, can enhance the operational efficiency of the above methods.

Software defined by FIG. 2 can be written in a wide variety of programming languages, as will be appreciated by those skilled in the art.

The foregoing merely illustrates the principles of the invention. Various modifications and alterations to the described embodiments will be apparent to those skilled in the art in view of the teachings herein. For example, this methodology may be modified to analyze markets other than medical and pharmaceutical products. This methodology may also be modified to use indicators other than the four described herein. It will thus be appreciated that those skilled in the art will be able to devise numerous systems and methods which, although not explicitly shown or described herein, embody the principles of the invention and are thus within the spirit and scope of the invention.

We claim:

1. A method for categorizing a medical or a pharmaceutical product comprising the steps of:
(a) determining an originator indicator for the product;
(b) determining a patent status indicator for the product;
(c) determining a source indicator for the product;
(d) determining a tradename indicator for the product; and
(e) categorizing the product as a branded product or a generic product, using said originator indicator, said patent status indicator, said source indicator, and said tradename indicator determined in steps (a)-(d).

2. The method of claim 1, wherein step (e) comprises categorizing the product as a product selected from the group consisting of a branded product, a generic product, and an other product, using said originator indicator, said patent status indicator, said source indicator, and said tradename indicator determined in steps (a)-(d).

3. The method of claim 1, wherein step (e) comprises categorizing a product as a product selected from the group consisting of a branded product, a generic product, a branded generic product, and an other product, using said originator indicator, said patent status indicator, said source indicator, and said tradename indicator determined in steps (a)-(d).

4. The method of claim 1,
wherein the originator indicator classifies the product as a product selected from the group consisting of originator, non-originator, and other;
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

5. The method of claim 2,
wherein the originator indicator classifies the product as a product selected from the group consisting of originator, non-originator, and other;
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

6. The method of claim 3,
wherein the originator indicator classifies the product as a product selected from the group consisting of originator, non-originator, and other;
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

7. The method of claim 1,
wherein the originator indicator classifies the product as a product selected from the group consisting of originator, non-originator, non-applicable over the counter, other non-applicable, unknown, and other;
wherein the patent status indicator classifies the product as a product selected from the group consisting of on-patent, off-patent, over the counter, and other;
wherein the source indicator classifies the product as a product selected from the group consisting of single source, multiple source, co-licensed, over the counter, and other; and
wherein the tradename indicator classifies the product as a product selected from the group consisting of tradename, non-tradename, over the counter, and other.

8. The method of claim 4, wherein the product is categorized as a branded product, if
(i) the originator indicator classifies the product as originator,
(ii) the patent status indicator classifies the product as on-patent or off-patent;
(iii) the source indicator classifies the product as a product selected from the group consisting of single-source, multi-source, and co-licensed; and
(iv) the tradename indicator classifies the product as tradename or non-tradename.

9. The method of claim 4, wherein the product is categorized as a branded product, if
(i) the originator indicator classifies the product as non-originator;
(ii) the patent status indicator classifies the product as on-patent;
(iii) the source indicator classifies the product as a product selected from the group consisting of single-source, multi-source, and co-licensed; and
(iv) the tradename indicator classifies the product as tradename or non-tradename.

10. The method of claim 4, wherein the product is categorized as a generic product, if
(i) the originator indicator classifies the product as non-originator;
(ii) the patent status indicator classifies the product as off-patent;
(iii) the source indicator classifies the product as multi-source; and
(iv) the tradename indicator classifies the product as non-tradename.

11. The method of claim 5, wherein the product is categorized as an other product, if
the originator indicator classifies the product as non-applicable over the counter, other non-applicable, unknown, other, or a non-existing category.

12. The method of claim 5, wherein the product is categorized as an other product, if
the patent status indicator classifies the product as a product selected from the group consisting of over the counter, other, and a non-existing category.

13. The method of claim 5, wherein the product is categorized as an other product, if
the source indicator classifies the product as over the counter, other, or a non-existing category.

14. The method of claim 5, wherein the product is categorized as an other product, if
the tradename indicator classifies the product as over the counter, other, or a non-existing category.

15. The method of claim 6, wherein the product is categorized as a branded generic product, if
(i) the originator indicator classifies the product as non-originator;
(ii) the patent status indicator classifies the product as off-patent;
(iii) the source indicator classifies the product as a product selected from the group consisting of single-source, multi-source, and co-licensed; and
(iv) the tradename indicator classifies the product as tradename.

16. The method of claim 6, wherein the product is categorized as a branded generic product,
if the originator indicator classifies the product as non-originator;
if the patent status indicator classifies the product as off-patent;
if the source indicator classifies the product as single-source or co-licensed; and
if the tradename indicator classifies the product as non-tradename.

17. A system for categorizing a medical or a pharmaceutical product comprising:
(a) an input device for inputting product information;
(b) a processor coupled to the input device, using said product information, for
(i) determining a patent originator indicator for the product;
(ii) determining a patent status indicator for the product;
(iii) determining a source indicator for the product;
(iv) determining a tradename indicator for the product; and
(v) categorizing the product as a branded product or a generic product using said originator indicator, said patent status indicator, said source indicator, and said tradename indicator determined in steps (i)-(iv); and
(c) a storage device coupled to the processor for storing the originator indicator, the patent status indicator, the source indicator, and the tradename indicator for the product.

18. The system of claim 17, wherein step (v) comprises categorizing the product as a product selected from the group consisting of a branded product, a generic product, and an other product, using said originator indicator, said patent status indicator, said source indicator, and said tradename indicator determined in steps (i)-(iv).

19. The system of claim 17, wherein step (v) comprises categorizing a product as a product selected from the group consisting of a branded product, a generic product, a branded generic product, and an other product, using said originator indicator, said patent status indicator, said source indicator, and said tradename indicator determined in steps (i)-(iv).

20. The system of claim 17,
wherein the originator indicator classifies the product as a product selected from the group consisting of originator, non-originator, and other;
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

21. The system of claim 18,
wherein the originator indicator classifies the product as a product selected from the group consisting of originator, non-originator, and other,
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

22. The system of claim 19,
wherein the originator indicator classifies the product as a product selected from the group consisting of originator, non-originator, and other;
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

23. The system of claim 17,
wherein the originator indicator classifies the product as a product selected from the group consisting of originator, non-originator, non-applicable over the counter, other non-applicable, unknown, and other;
wherein the patent status indicator classifies the product as a product selected from the group consisting of on-patent, off-patent, over the counter, and other;
wherein the source indicator classifies the product as a product selected from the group consisting of single source, multiple source, co-licensed, over the counter, and other; and
wherein the tradename indicator classifies the product as a product selected from the group consisting of tradename, non-tradename, over the counter, and other.

24. The system of claim 20, wherein the processor categorizes the product as a branded product, if
(i) the originator indicator classifies the product as originator;
(ii) the patent status indicator classifies the product as on-patent or off-patent;
(iii) the source indicator classifies the product as a product selected from the group consisting of single-source, multi-source, and co-licensed; and
(iv) the tradename indicator classifies the product as tradename or non-tradename.

25. The system of claim 20, wherein the processor categorizes the product as a branded product, if
(i) the originator indicator classifies the product as non-originator;
(ii) the patent status indicator classifies the product as on-patent;
(iii) the source indicator classifies the product as a product selected from the group consisting of single-source, multi-source, and co-licensed; and
(iv) the tradename indicator classifies the product as tradename or non-tradename.

26. The system of claim 20, wherein the processor categorizes the product as a generic product, if
(i) the originator indicator classifies the product as non-originator;
(ii) the patent status indicator classifies the product as off-patent;
(iii) the source indicator classifies the product as multi-source; and
(iv) the tradename indicator classifies the product as non-tradename.

27. The system of claim 21, wherein the processor categorizes the product as an other product, if
the originator indicator classifies the product as non-applicable over the counter, other non-applicable, unknown, other, or a non-existing category.

28. The system of claim 21, wherein the processor categorizes the product as an other product, if
the patent status indicator classifies the product as a product selected from the group consisting of over the counter, other, and a non-existing category.

29. The system of claim 21, the processor categorizes the product as an other product, if
the source indicator classifies the product as over the counter, other, or a non-existing category.

30. The system of claim 21, wherein the processor categorizes the product as an other product, if
the tradename indicator classifies the product as over the counter, other, or a non-existing category.

31. The system of claim 22, wherein the processor categorizes the product as a branded generic product, if
(i) the originator indicator classifies the product as non-originator;
(ii) the patent status indicator classifies the product as off-patent;
(iii) the source indicator classifies the product as a product selected from the group consisting of single-source, multi-source, and co-licensed; and
(iv) the tradename indicator classifies the product as tradename.

32. The system of claim 22, wherein the processor categorizes the product as a branded generic product,
if the originator indicator classifies the product as non-originator;
if the patent status indicator classifies the product as off-patent;
if the source indicator classifies the product as single-source or co-licensed; and
if the tradename indicator classifies the product as non-tradename.

33. A computer-readable medium for categorizing a medical or a pharmaceutical product, the computer-readable medium having a set of instructions operable to direct a processor to perform the steps of:
(a) determining an originator indicator for the product;
(b) determining a patent status indicator for the product;
(c) determining a source indicator for the product;
(d) determining a tradename indicator for the product; and
(e) categorizing the product as a branded product or a generic product, using said originator indicator, said patent status indicator, said source indicator, and said tradename indicator determined in steps (a)-(d).

34. The computer-readable according to claim 33, wherein step (e) comprises categorizing the product as a product selected from the group consisting of a branded product, a generic product, and an other product, using said originator indicator, said patent status indicator, said source indicator, and said tradename indicator determined in steps (a)-(d).

35. The computer-readable according to claim 33, wherein step (e) comprises categorizing a product as a product selected from the group consisting of a branded product, a generic product, a branded generic product, and an other product, using said originator indicator, said patent status indicator, said source indicator, and said tradename indicator determined in steps (a)-(d).

36. The computer-readable according to claim 33,
wherein the originator indicator classifies the product as a product selected from the group consisting of originator, non-originator, and other;
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

37. The computer-readable according to claim 34,
wherein the originator indicator classifies the product as a product selected from the group consisting of originator, non-originator, and other;
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

38. The computer-readable according to claim 35,
wherein the originator indicator classifies the product as a product selected from the group consisting of originator, non-originator, and other;
wherein the patent status indicator classifies the product as a product selected from the group consisting of on-patent, off-patent, and other;
wherein the source indicator classifies the product as a product selected from the group consisting of single source, multiple source, co-licensed, and other; and
wherein the tradename indicator classifies the product as a product selected from the group consisting of tradename, non-tradename, and other.

39. The computer-readable according to claim 33,
wherein the originator indicator classifies the product as a product selected from the group consisting of originator, non-originator, non-applicable over the counter, other non-applicable, unknown, and other;
wherein the patent status indicator classifies the product as a product selected from the group consisting of on-patent, off-patent, over the counter, and other;
wherein the source indicator classifies the product as a product selected from the group consisting of single source, multiple source, co-licensed, over the counter, and other; and
wherein the tradename indicator classifies the product as a product selected from the group consisting of tradename, non-tradename, over the counter, and other.

40. The computer-readable according to claim 36, wherein the computer-readable medium is operable to direct the processor to categorize a product as a branded product, if
(i) the originator indicator classifies the product as originator;
(ii) the patent status indicator classifies the product as on-patent or off-patent;
(iii) the source indicator classifies the product as a product selected from the group consisting of single-source, multi-source, and co-licensed; and
(iv) the tradename indicator classifies the product as tradename or non-tradename.

41. The computer-readable according to claim 36, wherein the computer-readable medium is operable to direct the processor to categorize a product as a branded product, if
(i) the originator indicator classifies the product as non-originator;
(ii) the patent status indicator classifies the product as on-patent;
(iii) the source indicator classifies the product as a product selected from the group consisting of single-source, multi-source, and co-licensed; and
(iv) the tradename indicator classifies the product as tradename or non-tradename.

42. The computer-readable according to claim 36, wherein the computer-readable medium is operable to direct the processor to categorize a product as a generic product, if
(i) the originator indicator classifies the product as non-originator;
(ii) the patent status indicator classifies the product as off-patent;
(iii) the source indicator classifies the product as multi-source; and
(iv) the tradename indicator classifies the product as non-tradename.

43. The computer-readable according to claim 37, wherein the computer-readable medium is operable to direct the processor to categorize a product as an other product, if
the originator indicator classifies the product as non-applicable over the counter, other non-applicable, unknown, other, or a non-existing category.

44. The computer-readable according to claim 37, wherein the computer-readable medium is operable to direct the processor to categorize a product as an other product, if
the patent status indicator classifies the product as a product selected from the group consisting of over the counter, other, and a non-existing category.

45. The computer-readable according to claim 37, wherein the computer-readable medium is operable to direct the processor to categorize a product as an other product, if
the source indicator classifies the product as over the counter, other, or a non-existing category.

46. The computer-readable according to claim 37, wherein the computer-readable medium is operable to direct the processor to categorize a product as an other product, if
the tradename indicator classifies the product as over the counter, other, or a non-existing category.

47. The computer-readable according to claim 38, wherein the computer-readable medium is operable to direct the processor to categorize a product as a branded generic product, if
(i) the originator indicator classifies the product as non-originator;
(ii) the patent status indicator classifies the product as off-patent;
(iii) the source indicator classifies the product as a product selected from the group consisting of single-source, multi-source, and co-licensed; and
(iv) the tradename indicator classifies the product as tradename.

48. The computer-readable according to claim 38, wherein the computer-readable medium is operable to direct the processor to categorize a product as a branded generic product,
if the originator indicator classifies the product as non-originator;
if the patent status indicator classifies the product as off-patent;
if the source indicator classifies the product as single-source or co-licensed; and
if the tradename indicator classifies the product as non-tradename.
